(19) United States
(12) Patent Application Publication
(10) Pub. No.: US 2026/0034850 A1
(43) Pub. Date: Feb. 5, 2026

(54) HOUSING ASSEMBLY, HEATING DEVICE COMPRISING SAME, AND METHOD FOR PRODUCING THE HEATING DEVICE

(71) Applicant: Webasto SE, Stockdorf (DE)

(72) Inventors: Peter Neidenberger, Stockdorf (DE); Peter Mogl, Stockdorf (DE); Christoph Fuchs, Stockdorf (DE); Patrick Rau, Stockdorf (DE); Vanessa Seitz-Günther, Stockdorf (DE)

(21) Appl. No.: 19/099,545

(22) PCT Filed: Jul. 27, 2023
(86) PCT No.: PCT/EP2023/070942

§ 371 Date: Jan. 29, 2025

(30) Foreign Application Priority Data
Jul. 29, 2022 (DE) 10 2022 207 876.4

(51) Int. Cl. B60H 1/00

(52) U.S. Cl. CPC B60H 1/00507

(57) ABSTRACT

A housing assembly for a heater (10) for a motor vehicle or a construction machine, comprises a housing with a first housing part (11), which at least partially encloses an interior of the housing and has an outer surface (14), within which a partial surface region (16) is predetermined, and at least one connection member (40), wherein the connection member (40) has a first section (42) for connecting to the outer surface (14) of the first housing part (11) and a second section (43) for connecting to a fastening section provided on the vehicle side, in order to spatially fix the heater (10) in or at the motor vehicle, wherein the first section (42) of the connection member (40) is attached to the outer surface (14) within the predetermined partial surface region (16) in a materially bonded or form-fitting and force-fitting manner.

### TECHNICAL FIELD

Various aspects relate to a housing assembly, a heater comprising same, and a method for manufacturing the heater. In particular, they relate to mechanical elements that allow a spatially fixed, secure, and permanent connection of the housing assembly or the heater in or at a motor vehicle, a construction machine, or the like.

### TECHNICAL BACKGROUND

Heaters for motor vehicles or construction machines are widely known, in particular also as auxiliary heaters or recently also in electrically operated motor vehicles or construction machines as actual or supporting heating solution during driving operation or also in stationary mode. Such heaters can be designed as heaters operated by combustion of fuels or increasingly also as electric heaters. The heaters regularly comprise a housing that is constructed compactly in order to be accommodated in a space-saving manner, for example, in the engine compartment (in particular in the case of passenger cars) or within the passenger compartment (in particular in the case of trucks). The housing accommodates in its interior the functional components of the heater, for example, an electronic controller, a heat exchanger, a combustion chamber, fluid channels (for fuel, heat transport medium such as, for instance, water, combustion air, exhaust gas), etc., depending on whether it is an electric or a fossil fuel-consuming heater.

Usually, such heaters are delivered to the vehicle manufacturer as initial equipment, but a subsequent installation is equally possible in many applications. All the standard parts necessary for the installation are contained in the scope of shipment. For the installation, this generally also includes, inter alia, a vehicle-specific heater holder. Specifically, although the vehicle manufacturers offer mechanical fastening sections for the heater in the region of the corresponding installation space in the vehicle, these are generally located at completely different spatial positions depending on the vehicle type and are also largely non-uniform in their type (through holes, threads, etc.). A standardized fastening interface is therefore not yet available by the vehicle manufacturers.

However, the situation also looks similar on the side of the heaters. Depending on the type, these are manufactured with an individual housing that usually specifies a number of mechanical fastening points. These fastening points are regularly designed as blind holes for self-tapping screws, threads or through holes and are integrated in an existing component of the housing such as, for example, a heat exchanger that can itself form a housing part (for example, a housing cover or a housing base part). Consequently, the mechanical fastening interface, which is inflexible in terms of its position, location, and design, can be used at the heaters at most in exceptional cases as a direct connection to the vehicle.

One example is described in document WO 2020/030306 A1. The heater disclosed therein comprises a housing cover and a housing base part, wherein both housings parts have reinforcing ribs that form a reinforcing grid structure. Within individual reinforcing ribs, fastening devices are provided as cylindrical receptacles (blind holes). Fastening means such as, for instance, screws or pins or the like can be inserted therein. The fastening devices and fastening means are intended to allow secure holding at a vehicle-specific holder that is not shown in the document, however.

Those vehicle-specific heater holders that are also supplied with the heaters and that are consequently fastened at the fastening sections of the motor vehicle on the one side and at the fastening points at the heater on the other side thus represent a mechanical interface that is individualized for the respective motor vehicle (or the construction machine). An obvious disadvantage is that additional parts and unnecessary additional weight are produced at the vehicle by the vehicle-specific holders.

Furthermore, because either the mechanical heater interface or the vehicle-specific holder has to be adapted even in the case of slight changes with regard to the fastening sections at the vehicle, a new vehicle-specific holder has to be developed with each changed product or vehicle design and also tested with regard to the fulfillment of safety requirements. All of this leads to significantly higher efforts and costs.

A further aspect represents the assembly aid required by many vehicle manufacturers. In this case, for example, a further holder to which the heater is merely coupled (attached) temporarily in order to be able to carry out the steps of the actual assembly with both hands is regularly to be used in addition. However, such a holder for the assembly aid further impairs the abovementioned efficiency with regard to efforts and costs.

Furthermore, it should also be mentioned that the known heaters, such as, for instance, the mechanical fastening features described in WO 2020/030306 A1, are designed as blind holes for self-tapping screws or threads, so that the tolerance compensation required for the assembly necessarily has to be provided either on the vehicle side or on the side of the vehicle-specific holder, which can have an unfavorable effect for the supplier of the relevant heater if competitors can offer a heater with this tolerance compensation.

Consequently, there is a need for savings in costs and a reduction in the effort and the number and/or the scope of the parts required for the assembly and the final fixing of a heater in or at the vehicle.

### SUMMARY OF THE INVENTION

Aspects of the invention relate to a housing assembly for a heater for a motor vehicle or a construction machine. Such a housing assembly may basically include a single-part or multi-part housing, generally two housing parts, namely housing base part and housing cover. Aspects of the invention in any case start from a housing with at least one first housing part. The first housing part at least partially encloses an interior of the housing (if it is, for example, a housing cover or a housing base part), and it has an outer surface, within which a special partial surface region for the connection to the vehicle is predetermined.

In addition to the housing with the first housing part, the housing assembly comprises at least one connection member. The connecting element in this case has a first section for connecting to the outer surface of the first housing part and a second section for connecting to a fastening section provided on the vehicle side, in order to spatially fix the heater in or at the motor vehicle or the construction machine. The connection member may itself be a single-part or multi-part, but it is preferably a single-part, in order to achieve the goal of reducing and simplifying parts.

According to these aspects, the first section of the connection member is attached to the outer surface of the first housing part within the predetermined partial surface region in a materially bonded or form-fitting and force-fitting manner, without the first housing part having a fastening interface prepared for this purpose with a through-hole, elongated hole, blind hole or internally threaded passage with threaded bolts.

The basic idea is consequently to implement the mechanical fastening interface at the heater by means of a connection member (but in particular also a plurality thereof). The predetermined partial surface region of the outer surface allows a higher degree of freedom of the placement of the connection member at the first housing part during the assembly of the heater before delivery, for example to the vehicle manufacturer. It thus becomes possible, by suitable placement of the connection member(s), depending on the spatial conditions in the installation space of the motor vehicle or the construction machine and in particular on the distances and the orientation of the heater from the vehicle-side (or construction machine-side) fastening sections (or fastening devices), to select a suitable connection member(s) from a reasonably small number of connection members and to attach said connection member(s) in a flexible manner at the suitable position in the predetermined partial surface region. A vehicle-specific holder may consequently be dispensed with, because the heater can be fastened directly to the vehicle-specific fastening sections. The connection members may be preproduced as standard parts and used for different vehicle types. A connection member connects to one or more fastening section(s) of the vehicle. However, two different connection members may also connect to one and the same fastening section.

Furthermore, a seam-free (meaning: no passage therethrough) assembly at the first housing part by means of material bonding on the one side or force-fit and form-fit on the other side makes it possible to maintain the integrity (tightness) of the housing interior. According to one development, this applies in particular if the first housing part is one that accommodates on the inside a heat exchanger (usually comprising a plurality of rib structures made of a heat-conducting medium such as, for instance, metal), through which a fluid (e.g., water) flows, in order to transfer heat thereto, for example. Alternatively, a control device for the electric heater may be provided on the inside of the first housing part. Here, too, the tightness of the housing part with respect to the housing interior is extremely important and can be ensured by the features of the aspects described here.

As described above, therefore, in the prior art (for example, WO 2020/030306 A1), reinforcing ribs protruding in the outer surface of the respective housing part are used in order to form therein seam-free (no passage) blind holes, possibly with internal threads for receiving fastening screws, as fastening points. However, the reinforcing ribs hinder the determination of a partial surface region for a free and flexible placement of the connection members proposed herein, especially since the fastening points provided as blind holes, if these were to be used for a connection, define only a few discrete positions with virtually no tolerance on the surface of the housing part.

In summary, therefore, a high degree of flexibility for position and location as well as for design of the mechanical interface to the customer-specific motor vehicle or to the customer-specific construction machine may be achieved by the aspects proposed herein. The conventionally additional and sometimes very complex holder constructions can be saved both with regard to their development/design as well as with regard to the costs of the parts and the tool and assembly costs. At the same time, a direct connection of the heater to the customer interface can nevertheless be implemented. Furthermore, the connection members additionally required between the heater and the vehicle-specific holder are also saved.

According to a specific embodiment of the proposed housing assembly, the first section of the connection member is attached to the outer surface within the predetermined partial surface region in a materially bonded manner by gluing or welding, or in a form-fitting and force-fitting manner by clinching. Both attachment processes allow a mechanically secure and permanent connection to the first housing part. This applies in particular to clinching, also referred to as toxing (connecting without using additional material) or press joining, which represents an inexpensive connection technique with low effort and high efficiency with a high degree of safety and durability. The projection produced on the housing inner side by the partial “deep-drawing” is still entirely acceptable and acceptable in this technique due to the small size.

According to a further embodiment, the housing comprises the first housing part and a second housing part, wherein the first housing part is a housing cover and the second housing part is a housing base part. As mentioned above, the housing cover may accommodate a heat exchanger on its inner side. In an embodiment, the housing cover may a accommodate a heat exchanger on its inner side and the heat exchanger may form the corresponding housing base part. Since in such a construction (heat exchanger formed at or in the cover), which offers technical advantages per se, the integrity of the cover is particularly important, which is ensured by the attachment of the connecting element or elements according to the invention, further advantageous aspects of the invention are thus produced.

A further exemplary embodiment provides that the connection member is configured and the outer surface in the partial surface region is designed such that the connection member may be fastened to the first housing part on the outer surface within the fixed partial surface region at a plurality of positions and/or in a plurality of orientations relative to the housing part. This possibility is already indicated above. In this case, the partial surface region predetermined in the outer surface may particularly advantageously form a continuous, planar surface of the first housing part. The first section of the connection member may then have a planar contact surface matching it for connecting to the outer surface of the first housing part. This allows a flexible placement of the two surfaces (outer surface and contact surface) relative to each other.

However, it is equally possible that the surface is not planar but rounded or curved. One of the two surfaces may then be concavely shaped and the other convexly shaped to match it. Other surfaces matching each other geometries are equally possible. For example, the outer surface may have an elongated groove with side walls. Matching this, the contact surface of the connection member may have a projection with side walls. The connection member is then freely placeable during assembly along at least one longitudinal direction (1-dimensional). However, the 2-dimensional free placeability during assembly of the housing on an in particular planar surface is preferred.

Further exemplary embodiments provide that at least one bead, in particular a groove or an embossing, is configured for stiffening the housing part within the predetermined partial surface region and all around delimited by the latter. In contrast to a protruding part of the outer surface serving for stiffening, a groove or deep-drawn embossing may be bridged by the contact surface of the connection member. Attachment points of the connection member may in this case lie on both sides of the groove, etc. The bead itself does not belong to the predetermined partial surface region.

According to exemplary embodiments, the flexibility in the placement of the connection member is greater if the surface portion of the partial surface region is also increased. If the first housing part is a flat component with a main surface and a surface normal arranged thereon, then, in a plan view of the component along this surface normal, the surface portion of the predetermined partial surface region may particularly advantageously amount to 30% or more, preferably 40% or more, further preferably 50% or, or particularly preferably 60% or more of the total surface of the first housing part projected into a plane. In specially cases, up to 70% or even more may be achieved.

The connection member may be formed from a metal, preferably aluminum or steel. The combination of two materials (in particular metals, but also plastics) among the connection member(s) and the first housing part is also possible. The first and/or the second housing part may likewise be formed from steel or aluminum. Thermally resistant and mechanically loadable plastics are also possible in each case for the housing parts and/or the connection members.

According to one exemplary embodiment, in the second section for connecting to a fastening section provided on the vehicle side, the connection member may have at least one prepared fastening interface, in particular a through-hole, elongated hole, internally threaded passage, pin or threaded bolt. In this region of the connection member, which may represent by way of example an end of an elongated connection member opposite the first section, simple, conventional fastening mechanisms are readily possible. In the assembled state, the second section is spaced apart from the outer surface, or the end points away from the outer surface.

According to a further aspect, the first section of the connection member is attached to the outer surface in a materially bonded or alternatively form-fitting and force-fitting manner at at least two points spaced apart from one another on its contact surface. This considerably improves the stability and durability of the connection. The feature also applies in particular to the adhesive, welding or clinching processes mentioned by way of example.

As mentioned, the connection member may have an elongated shape with two ends which are formed by the two sections. In the assembled state, the second section extends laterally—as viewed in plan view—beyond the edge of the first housing part and away from the outer surface. How far and in which direction the corresponding second end extends with the second section depends on the vehicle type provided. However, the connection members may also have elongated and angled shapes in order to achieve desired geometry options.

A particular advantage may arise if two or more connection members of substantially identical construction to each other are provided. A three-point mounting of the heater with three connection members that are positioned or placed at selected positions in the partial surface region of the outer surface would be ideal, so that they thus reach the fastening sections on the vehicle side and allow a mechanical fixing thereto.

According to a specific embodiment, connection members are attached in the same way at different positions spaced apart from one another within the predetermined region of the outer surface. In this case, two or more connection members of substantially identical construction to each other may be provided, which are attached in the same way at different positions spaced apart from one another within the predetermined region of the outer surface (clinching, welding, gluing, etc., see above).

The portion of identical parts at the heater can thereby be maximized with full flexibility of the mechanical fastening interface. The connection members may be fastened to all suitable heater components, without producing a new variant of the heater. If the connection members are different from one another, this allows a modular construction principle during assembly of the heater.

Customer-specific or vehicle-specific, separate connection members may possibly also be developed and fastened to the heater. Depending on the customer or vehicle manufacturer's wishes, the connection members may also include decoupling or assembly aids.

The connection member(s) may be equipped as different standard parts with a through-hole, elongated hole, internally threaded passage or threaded bolts and likewise include an assembly aid (hanging feature). Clip solutions and insertion geometries are likewise possible. By using different connection geometries, the tolerance compensation required for the assembly can be implemented.

The individualization of the heater may take place at any desired point in time in the manufacturing process, so that variants may also be produced only late in production.

Due to the high flexibility at assembly points on the heater, a compact design of the connection members can be implemented, which leads to weight and material savings.

A further aspect of the invention provides a heater which comprises the housing described above. The heater may be of the combustion type or of the electrically driven type, and the invention is not limited to specific shapes and types. This aspect incorporates the effects already described.

Further aspects of the invention provide a corresponding method for manufacturing the heater. It may comprise the following steps:
providing the housing with the first housing part, which at least partially encloses an interior of the housing and has the outer surface, within which the partial surface region is predetermined;
specifying an attachment position of the heater with respect to a fastening section provided on the vehicle side in a motor vehicle or a construction machine;
depending on the specified attachment position, selecting and determining:
   at least one connection member for fastening to the fastening section in the motor vehicle or the construction machine; and
   a position within the partial surface region of the surface for attaching the first section to the surface;
attaching the selected connection member in a materially bonded or form-fitting and force-fitting manner with its first section to the outer surface within the predetermined partial surface region at the determined position, without the first housing part having at this position a fastening interface prepared for this purpose with a through-hole, elongated hole, blind hole or internally threaded passage with threaded bolts.

Some advantages have already been described above with regard to the housing assembly. However, it should be mentioned that the assembly of the connection members to the heater can take place in all assembly steps until shortly before the final assembly of the heater. This considerably simplifies the production planning and the effort.

Furthermore, in the case of a specific product, any design changes of the interface to the customer may also be taken into account, for example, by a variable arrangement (e.g. change in angle or position) of the connection member at the heater.

A further embodiment of the method provides, for example, a step of installing functional components of the heater, including a heat exchanger and an electronic controller, which is carried out before the attachment of the connection member to the surface of the first housing part. The heater as such can accordingly already be produced almost completely, wherein the connection members are only added when it is established in which vehicle type the heater is installed.

Further advantages, features and details of the various aspects result from the claims, the following description of preferred embodiments and with reference to the drawings. In the figures, the same reference numerals designate the same features and functions.

### BRIEF DESCRIPTION OF THE DRAWINGS

In the drawings:

FIG. 1 shows, in a perspective illustration in plan view, a first housing part with an arrangement of three connection members mounted on its surfaces according to a first exemplary embodiment;

FIG. 2 as in FIG. 1, with a partial surface region of the outer surface that is emphasized by dashed lines, in which connection members may be placed and attached;

FIG. 3 shows, in a perspective illustration in plan view, a first housing part with an arrangement of three connection members mounted on its surfaces according to a second embodiment;

FIG. 4 shows, in a flow diagram, an exemplary sequence of a method for manufacturing the housing assembly according to an embodiment

FIG. 5 shows in perpendicular plan view a first housing part having an arrangement of three connection members mounted on its surfaces according to a third embodiment.

### PREFERRED EMBODIMENT(S) OF THE INVENTION

In the following description of preferred embodiments, it is to be taken into account that the present disclosure of the various aspects is not limited to the details of the construction and the arrangement of the components as illustrated in the following description and in the figures. The embodiments can be put into practice or carried out in various ways. Furthermore, it is to be taken into account that the phraseology and terminology used here are used only for the purpose of the specific description and should not be interpreted by a person skilled in the art as such in a limiting manner. Furthermore, in the following description, the same reference numerals in the various embodiments or figures designate the same or similar features or objects, such that in some cases a repeated detailed description thereof is dispensed with in order to preserve the compactness and clarity of the illustration.

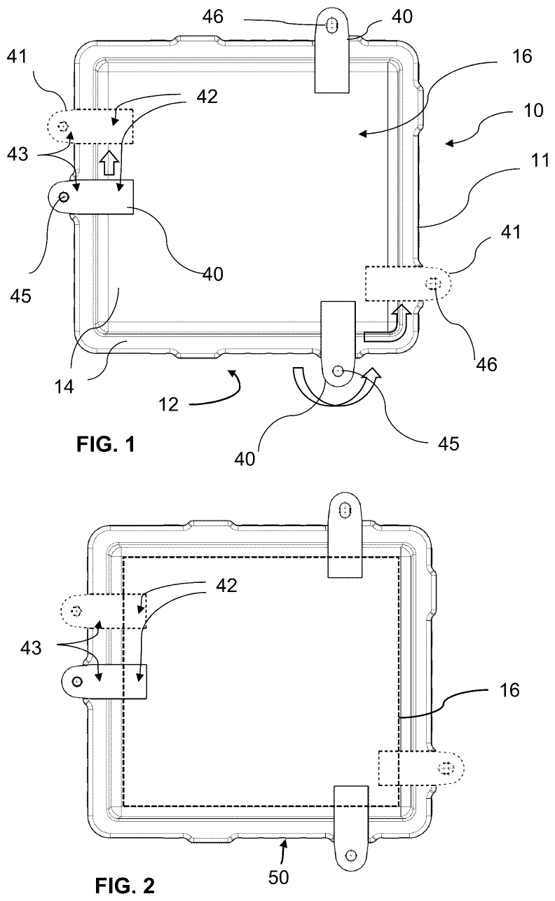

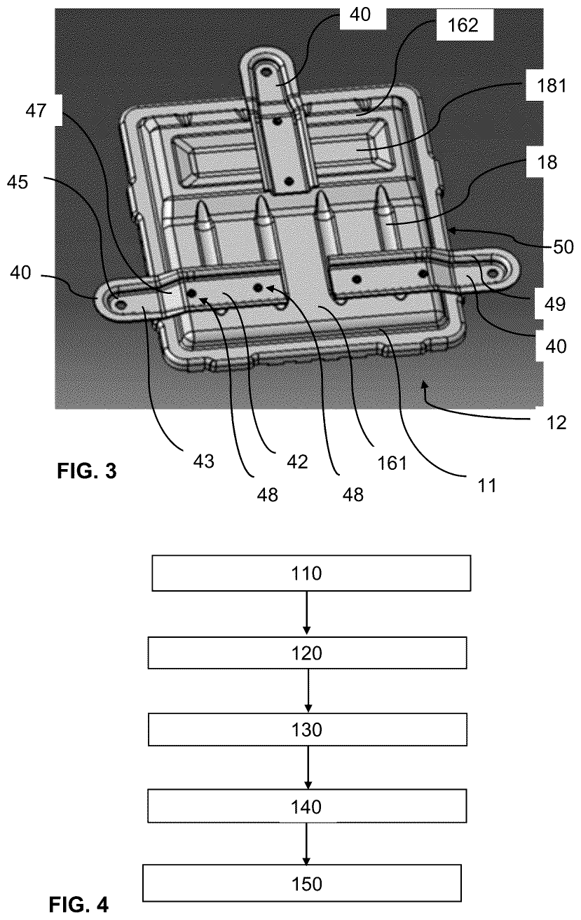

FIGS. 1 and 2 show a first embodiment of a housing assembly according to the present invention. FIG. 1 shows, in a schematic illustration, a plan view of a housing cover as a first housing part 11 of a heater 10 for motor vehicles or construction machines. A second housing part 12 is merely identified by the reference numeral with the corresponding arrow. In the assembled state, its position is located below the figure plane and is scarcely visible in plan view and is therefore omitted in FIG. 1 for the sake of simplicity (the same applies to FIGS. 2 and 3). The typical configuration of a second housing part 12 with respect to a first housing part may be gathered purely by way of example from the document mentioned at the outset relating to the prior art WO 2020/030306 A1 (but without taking over the mechanical fastening described therein, which is to be replaced in the embodiment by connection members according to the invention). The second housing part 12 may be provided with connections for the supply and discharge of the fluid (e.g., water) and for the electric power supply and controller. However, the connections may also be arranged distributed over both housing parts.

The first housing part 11 has a substantially square plan view in plan view with the base or main surface visible in this view. The first housing part 11 has a substantially flat trough-shaped construction with side walls of low depth which are not or scarcely visible in the figure. The first housing part 11 may be formed from a metal, e.g., steel, and is configured to be attached to a second housing part in order to jointly close off an interior. Control electronics, a power supply, heating electronics, fluid channels and a heat exchanger may be accommodated in the interior in order to name only a selection of components (not shown). In the embodiment, this is an electrically operated heater 10 (without combustion). In particular, the functional part corresponding to the heat exchanger may be coupled to the housing cover (first housing part 11) or with the housing base part (second housing part 12), or may form such component by itself.

The first housing part 11 has an outer surface 14 lying opposite the interior. A partial surface region 16 of this outer surface 14 is substantially flat or planar. Beads or embossings as stiffening structures are entirely possible, but not shown in FIGS. 1 and 2. They may be introduced into the partial surface region in an elongated extending shape. The partial surface region 16 occupies a large surface portion, e.g. 50-70% of the surface, if it is projected onto the figures in a planar manner along a surface normal (plan view) in FIG. 1, in this respect, see the surface drawn by dashed lines in FIG. 2.

Within the partial surface region 16, connection members 40 are attached that serve for a connection to fastening sections on the vehicle side, in order to spatially fix the heater to the vehicle. More precisely, only first sections 42 of the respective connection members 40 extend within the partial surface region 16. Planar contact surfaces of the connection members 40 likewise face the outer surface 14 within the partial surface region, and the contact surface and the outer surface 14 are connected to each other in a materially bonded or force-fitting and form-fitting manner at at least two points within the partial surface region 16. Opposite ends of the connection members 40 form second sections 43 that have no contact with the surface 14 in the partial surface region 16. These second sections extend beyond the edge 50 of the housing cover (first housing part 11) and each have a prepared fastening interface that is formed as a through-hole 45 or elongated hole 46. Other types of fastening interfaces 45, 46 are likewise possible, e.g. a threaded passage, pins, threaded bolts, etc. The connection members may be formed from a metal, e.g., aluminum or steel.

In FIG. 1, connection members 41 are drawn by dashed lines. In FIG. 1, they provide alternative placements for the corresponding connection members 40, as can be seen from the arrows. The different arrangement design may result from a variation of the fastening interface on the vehicle side. Since, according to one exemplary embodiment of the method according to the invention, it is possible to attach the connection members, e.g., only after completion of the assembly of the heater including the housing parts 11, 12, such a flexible placement of the connection members 40 of the embodiment, which are basically identical to each other, is also possible, e.g., only directly before delivery, depending on the dimensions and positions of the fastening interface on the vehicle side.

The wide-spaced partial surface region 16 allows a large selection of positioning options. The orientation of the connection members may also be changed, as is indicated, e.g., by the rotary arrow at the bottom in FIG. 1. The connection members 40 do not necessarily have to be oriented perpendicularly to the edge 50, beyond which they extend, but may also be arranged inclined with respect thereto.

FIG. 3 shows, in a perspective view, a second embodiment of a housing assembly or of a heater 10 (of which only the housing assembly can be seen). The view shows greater details, but is basically very similar to the first embodiment, so that only the differences are explained. Otherwise, what was stated above also applies to this embodiment.

The three connection members 40 are also of identical construction in this embodiment. They each have the first section 42, the second section 43, and also a transition section 47 between the first section 42 and the second section 43, which also allows an adaptation of the position of the relevant fastening interface (through-hole 45, elongated hole 46) in a direction along a surface normal to the main surface of the first housing part 11, so that a three-dimensional approach to the relevant fastening sections on the vehicle side (given a given location and position of the heater 10 in the vehicle space) is made possible.

The connection members 40 themselves are of elongated form and are surrounded, apart from at a head-side end of the first section 42, by a fold-like edge 49 that stiffens the connection member 40 and also offers a contact surface and an elastic clamping force after fixing to the fastening section on the vehicle side. The connection members 40 of.

FIG. 3 also shows, for each of the connection members 40, two points 49 spaced apart from one another, at which the contact surface of the connection member 40 is attached to the outer surface 14 in a materially bonded or alternatively form-fitting and force-fitting manner. In the second embodiment, it is striking that the planar partial surface 16 of the first exemplary embodiment is reproduced by two separate planar partial surface regions 161 and 162, in which beads 18 and 181 are additionally embossed. The contact surfaces of the connection members 40 bridge those beads 18 and 181, and the points 49 are located only where the contact surface is also in contact with the surface 14 in the partial surface region 16-in the specific embodiment on both of the respective embossings.

The planar partial surface regions 161, 162 of the outer surface 14 that are available for the placement occupy approximately a fraction 30%, or 10%, respectively, of the surface at the outer surface 14 projected onto the base surface of the first housing part 11.

FIG. 4 shows, schematically, the sequence of a method for manufacturing the housing assembly or the heater according to an embodiment. In a step 110, the housing with the first housing part 11, which at least partially encloses an interior of the housing and has the outer surface 14, within which the partial surface region 16 is predetermined, is provided.

In a step 120, functional components of the heater, including a heat exchanger and an electronic controller, are installed in the housing.

In a step 130, an attachment position of the heater with respect to a fastening section provided on the vehicle side in a motor vehicle or a construction machine is specified. This may also be based on requirements and information of the vehicle manufacturer.

In step 140, depending on the specified attachment position,
optionally at least one type of connection member 40 (optionally from a number of possible types of identical construction) for fastening to the fastening section in the motor vehicle or the construction machine is selected, and
a position and the orientation within the predetermined partial surface region 16 of the surface 14 for attaching the first section 42 of the connection member 40 to the surface 14 is determined or even calculated.

In step 150, the first section 42 of the selected connection member 40 is welded to the outer surface 18 within the predetermined partial surface region 16 at the determined position and with the determined orientation. At this position, the first housing part does not have a fastening interface prepared for this purpose with a through-hole, elongated hole, or internally threaded passage with threaded bolts.

The specifications and details provided in the specific embodiments are not to be interpreted in a limiting manner with respect to the scope of protection defined in the appended claims. Thus, further modifications are also possible. For example, as described above, a housing part and a predetermined partial surface region may be provided in the outer surface, but there may also be a case in which a plurality of housing parts are present, wherein the predetermined partial surface regions and the connection members fastened thereto may also be attached being distributed over both or a plurality of housing parts.

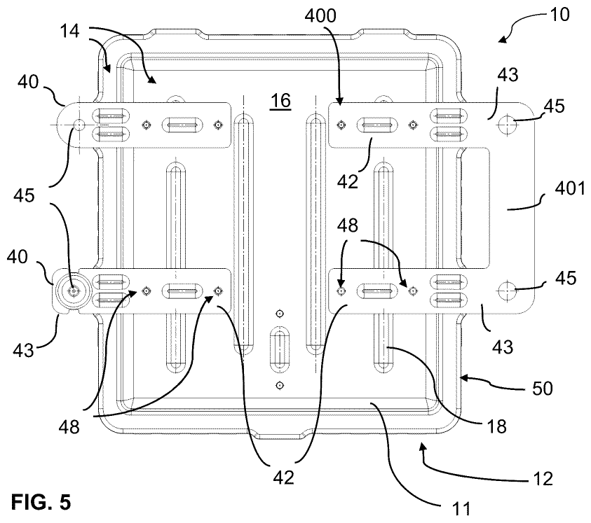

FIG. 5 shows a further, third embodiment of a first housing part 11 of a housing assembly for a heating device 10. It also applies here that the same reference numerals designate the same or similar technical features, so that in the case of repetition a detailed description can be dispensed with. The first housing part 11 forms a housing cover for the heating device 10. A counterpart forms the housing base part which simultaneously forms a heat exchanger and which represents a second housing part 12 of this embodiment, but cannot be seen in the plan view on the underside.

Similarly to the first and second embodiments, the first housing part 11 with the second housing part 12 has a substantially flat structure with an outer surface 14 which is opposite an interior (not shown). A large portion of the outer surface 14 is formed by a planar partial surface 16, approximately 50% in the plan view. This partial surface region or surface portion is available for a flexible positioning for here three connecting elements 40, 400. Two of the connection members 40 have an elongate structure as described above. They differ only insignificantly from one another.

A (one-piece) third connection member 400 is constructed as a (double) angle and has two parallel, elongate partial surface regions which each have the first section 42 for connection to the outer surface 14 or the partial surface region 16 of the first housing part 11 and the second section 43 for connection to a fastening section provided on the vehicle side. The second sections 43, which also have the through holes 45 for fastening, are connected to one another by a connecting section 401 which extends perpendicularly to the elongate partial surface regions and which gives the structure more stability. In the perpendicular plan view onto the planar partial surface 16, the second sections 43 extend laterally beyond the edge 50 in order to permit a connection in a plane which is achieved by the flat structural shape of the housing. In this case, the connecting section 401 projects almost completely beyond the edge 50.

In its first sections 42, the connection member 400 also has the two (or more) contact points 48 which are spaced apart from one another and are formed, for example, by clinching and at which the contact surface of the connection member 40 or 400 is attached to the outer surface 14 in any case by material bonding or alternatively in a form-fitting and force-fitting manner. In this case, the contact surfaces of the connection members 40 or 400, respectively, bridge beads 18 (recessed portions) which are formed in the outer surface 14, and in this embodiment, the points 48 are located only where the contact surface is also in contact with the surface 14 in the partial surface region 16.

It should be noted that further shapes than those shown in the embodiments are possible for the connection members. Modifications are also possible in the case of the connection members 400 which are formed as angles; for example, the angle does not need to be 90 degrees (as shown). Furthermore, connection members which are rather planar, non-elongate, but square, are also possible.

### LIST OF REFERENCE NUMERALS

10 Heater
11 First housing part
12 Second housing part
14 Outer surface
16 Partial surface region
161 First partial surface region
162 Second partial surface region
18 Bead, groove, embossing
181 further bead, embossing
40 connection member
41 connection member (repositioned)
42 first section (connection member)
43 second section (connection member)
45 through-hole
46 elongated hole
47 (third) transition section (connection member)
48 point (connection by clinching or welding or gluing)
49 fold-like edge
110—steps for assembly of the heater

1. Housing A housing assembly for a heater for a motor vehicle or a construction machine, comprising:
a housing with a first housing part, which at least partially encloses an interior of the housing and has an outer surface, within which a partial surface region is predetermined; and
at least one connection member, wherein the connection member has a first section for connecting to the outer surface of the first housing part and a second section for connecting to a fastening section provided on the vehicle side, in order to spatially fix the heater in or at the motor vehicle or the construction machine,
wherein the first section of the connection member is attached to the outer surface within the predetermined partial surface region in a materially bonded or form-fitting and force-fitting manner.

2. The housing assembly according to claim 1, wherein
the first section of the connection member is attached to the outer surface within the predetermined partial surface region in a materially bonded manner by gluing or welding or in a form-fitting and force-fitting manner by clinching.

3. The housing assembly according to claim 1, wherein the first housing part is a component forming a heat exchanger of the heater, or is a component accommodating a heat exchanger.

4. The housing assembly according to claim 1, wherein
the housing comprises the first housing part and a second housing part, wherein the first housing part is a housing cover and the second housing part is a housing base part.

5. The housing assembly according to claim 1, wherein
the connection member is configured and the outer surface in the partial surface region is designed such that the connection member may be fastened to the first housing part on the outer surface within the predetermined partial surface region at a plurality of positions and/or in a plurality of orientations relative to the first housing part, and
the partial surface region predetermined in the outer surface is a continuous, planar surface of the first housing part, wherein the first section of the connection member has a planar contact surface matching it for connecting to the outer surface of the first housing part.

6. The housing assembly according to claim 5, wherein
at least one bead is provided for stiffening the first housing part within the predetermined partial surface region and all around delimited by the latter.

7. The housing assembly according to claim 5, wherein
the first housing part is a flat component with a main surface and a surface normal arranged thereon, wherein, in a plan view of the component along this surface normal, the surface portion of the predetermined partial surface region amounts to 30% or more, of the entire surface of the first housing part projected into a plane.

8. The housing assembly according to claim 1, wherein
the connection member is formed from a metal.

9. The housing assembly according to claim 1, wherein
in the second section for connecting to a fastening section provided on the vehicle side, the connection member has at least one prepared fastening interface.

10. The housing assembly according to claim 9, wherein
the first section of the connection member is attached to the outer surface in a materially bonded or alternatively form-fitting and force-fitting manner at at least two points spaced apart from one another on its contact surface.

11. The housing assembly according to claim 1, wherein
the connection member has an elongated shape and/or is designed as an angle.

12. The housing assembly according to claim 1, wherein
the connection member extends laterally, as viewed in plan view onto the partial surface region of the outer surface, beyond the edge of the first housing part.

13. The housing assembly according to claim 1, wherein
two or more connection members of substantially identical construction to each other are provided, which are attached in the same way at different positions spaced apart from one another within the predetermined partial surface region of the outer surface.

14. A heater for a motor vehicle or a construction machine, comprising the housing assembly according to claim 1.

15. A method for manufacturing the heater according to claim 14, comprising:
providing the housing with the first housing part, which at least partially encloses an interior of the housing and has the outer surface, within which the partial surface region is predetermined;
specifying an attachment position of the heater with respect to a fastening section provided on the vehicle side in a motor vehicle or a construction machine;
depending on the specified attachment position, selecting and determining-:
at least one connection member for fastening to the fastening section in the motor vehicle or the construction machine; and
a position within the partial surface region of the surface for attaching the first section to the surface;
attaching the selected connection member in a materially bonded or form-fitting and force-fitting manner with its first section to the outer surface within the predetermined partial surface region at the determined position, without the first housing part having at this position a fastening interface prepared for this purpose with a through-hole, elongated hole, or internally threaded passage with threaded bolts.

16. The method according to claim 15, comprising a step of installing functional components of the heater, including a heat exchanger and an electronic controller, in the housing, which is carried out before the attachment of the connection member to the surface of the first housing part.

17. The housing assembly according to claim 3, wherein the first housing part is a component which interacts with the heat exchanger by closing an inner space of the housing as a cover.

18. The housing assembly according to claim 6, wherein the at least one bead is a groove or an embossing.

19. The housing assembly according to claim 5, wherein the first housing part is a flat component with a main surface and a surface normal arranged thereon, wherein, in a plan view of the component along this surface normal, the surface portion of the predetermined partial surface region amounts to 60% or more of the entire surface of the first housing part projected into a plane.

20. The housing assembly according to claim 9, wherein the at least one prepared fastening interface is a through-hole, elongated hole, internally threaded passage, pin or threaded bolt.
